(19) United States
(12) Patent Application Publication
(10) Pub. No.: US 2008/0120805 A1
(43) Pub. Date: May 29, 2008

(54) Rotating hinge with an elevating structure

(75) Inventor: Ding-Hone Su, Taipei County (TW)

Correspondence Address: BIRCH STEWART KOLASCH & BIRCH, PO BOX 747, FALLS CHURCH, VA, 22040-0747, US

(73) Assignee: Sinher Technology Inc.

(21) Appl. No.: 11/604,799

(22) Filed: Nov. 28, 2006

(51) Int. Cl. E05D 7/04

(52) U.S. Cl. 16/239

(57) ABSTRACT

A rotating hinge capable of driving a screen to ascend or descend includes a fixed base and a rotating support base. The fixed base has a guide plate with external positioning grooves corresponding to internal positioning grooves for pressing the guide plate, a limit plate linked to the rotating support base and corresponding to the internal and external positioning grooves, and internal positioning protrusion and external positioning protrusion. When the rotating support base is rotating, the positioning grooves and positioning protrusions rise. After the rotating support base rises, a four-point contact can be maintained stably to prevent and resist vibrations. When the rotating support base is rotated to a predetermined position, the positioning grooves and positioning protrusions will match with each other, and the rotating support base will be descended to a position to improve the touch feel and stability of driving a screen to ascend or descend.

### FIELD OF THE INVENTION

The present invention relates to a rotating hinge with an elevating structure, and more particularly to a rotating hinge capable of elevating a screen to a fixed position and producing touch feel when the screen is descended.

### BACKGROUND OF THE INVENTION

In general, a 3C electronic device such as a notebook computer, a personal digital assistant (PDA) a digital camera and a mobile phone, a display and a main body of the electronic device are pivotally connected by a hinge, so that the display can be spread open when the electronic device is in use, or the display can be can be folded onto the main body to reduce the volume for storage and carrying when the electronic device is not in use.

As conventional rotating hinges do not come with a screen elevating structure, the screen may rub a keyboard easily if the screen is rotated and the height is insufficient or the screen is titled. Therefore, it is necessary to elevate the screen, but such arrangement will adversely affect the harmonic appearance of the electronic device.

In a rotating structure as disclosed in R.O.C. Patent Publication No. 495130, a display can be rotated with respect to a main body, such that the display can be turned to provide different angles of views for users. The rotating structure comprises: a rotating base for forming a first cylindrical body, and both external edges of the first cylindrical body include a groove separately, and the two grooves are corresponsive to each other; a pivotal axle pivotally connected to a connecting side of the display and the rotating base; a fixing base fixed onto the main body for forming a second cylindrical body, and the second cylindrical body has a penetrating hole and two insert slots, and the penetrating hole is disposed at the central position of the second cylindrical body, and the penetrating hole is contained precisely in the rotating base, and the insert slots are formed at the penetrating hole, and the two insert slots are corresponsive to each other; and two resilient components contained in the insert slots, and each resilient component has a protruding edge; such that if the rotating base is rotated to a fixed position in the fixing base, the groove will be latched to the protruding edge for the positioning effect.

However, a poor design of the corresponding protruding edges and grooves of the foregoing rotating structure may affect the engagement of the protruding edge with the groove and limit the positioning effect and the touch feel of the positioning. In addition, such device obviously does not come with the function of limiting the rotating path of the display, so that a signal line of the display connected to the main body cannot be twisted too much, and the display must be turned less than 360 degrees with respect to the rotating path of the main body. Since the rotating path of the foregoing rotating structure is not limited, the signal line may be twisted and tangled and the electronic device may even be damaged easily.

### SUMMARY OF THE INVENTION

The primary objective of the present invention is to provide a rotating hinge with an elevating structure, particularly a rotating hinge applicable to a display of an electronic device. Besides the display can be rotated with respect to the main body of the electronic device, the screen of the display can be driven to elevate or descend with respect to the main body during the rotating process to prevent the display from touching a keyboard, such that the display can be installed at a lower position to reduce the overall volume of the electronic device and give a better and more harmonic appearance to the electronic device.

Another objective of the present invention is to provide a touch feel for the positioning when the display is turned to a predetermined position, so as to resist vibrations of the display and greatly improve the stability of the display.

To achieve the foregoing objectives, a preferred embodiment of the present invention includes a fixed base and a rotating support base that can be rotated with respect to each other. An upper end of the fixed base is fixed to a guide plate, and the guide plate has a through hole for passing a wire, two or more external positioning grooves corresponding to internal positioning grooves, and these positioning grooves are designed according to the required positioning angle such as 0 degree and 180 degrees when the hinge is rotated, and the two external positioning grooves are disposed equidistantly with 180 degrees apart at the external circumference of the guide plate, and the two internal positioning grooves are disposed equidistantly at the internal circumference of the through hole. The number and angle of the internal positioning grooves correspond to those of the internal positioning grooves and disposed alternatively with each other. A lower end of the rotating support base connects and presses the guide plate and a limit plate linked to the rotating support base. The limit plate includes a set of internal positioning protrusion and external positioning protrusion disposed at the positions corresponding to the internal and external positioning grooves of the guide plate. When the rotating support base and the fixed base are rotated, the positioning grooves and positioning protrusions drive the position of the rotating support base to elevate. After the rotating support base rises, there are four or more points of the positioning protrusions situated at the internal and external circumferences of the guide plate, such that a four-point contact can be maintained to prevent and resist vibrations after the rotating support base rises. After the rotating support base is turned to a predetermined position, the positioning grooves and positioning protrusions match with each other, and the rotating support base is descended to a fixed position to enhance the touch feel and the stability after the front side and backside of the screen are positioned.

### BRIEF DESCRIPTION OF THE DRAWINGS

FIG. 1 is a perspective view of an assembly of a preferred embodiment of the present invention;

FIGS. 2 and 3 are exploded views of a preferred embodiment of the present invention;

FIGS. 4A and 4B are side views of movements of a preferred embodiment of the present invention;

FIGS. 5A.5C are bottom views of movements of a preferred embodiment of the present invention;

FIG. 6 is a schematic view of a preferred embodiment applied to a notebook computer in accordance with the present invention;

FIGS. 7A and 7B show a perspective view and an exploded view of a structure of a second preferred embodiment of the present invention respectively; and

FIGS. 8A and 8B show a perspective view and an exploded view of a structure of a third preferred embodiment of the present invention respectively.

### DETAILED DESCRIPTION OF THE PREFERRED EMBODIMENTS

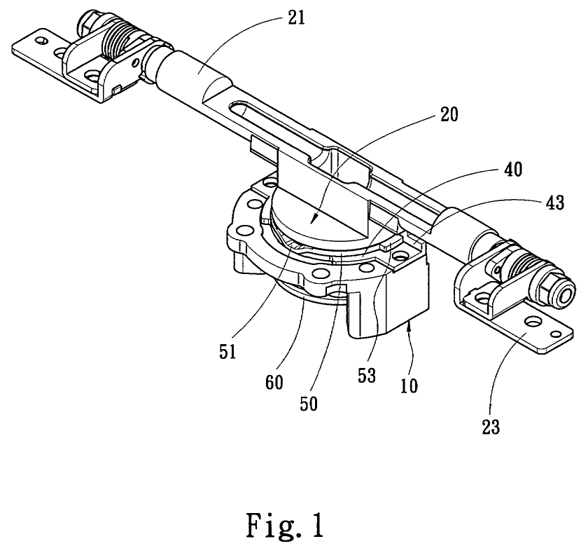

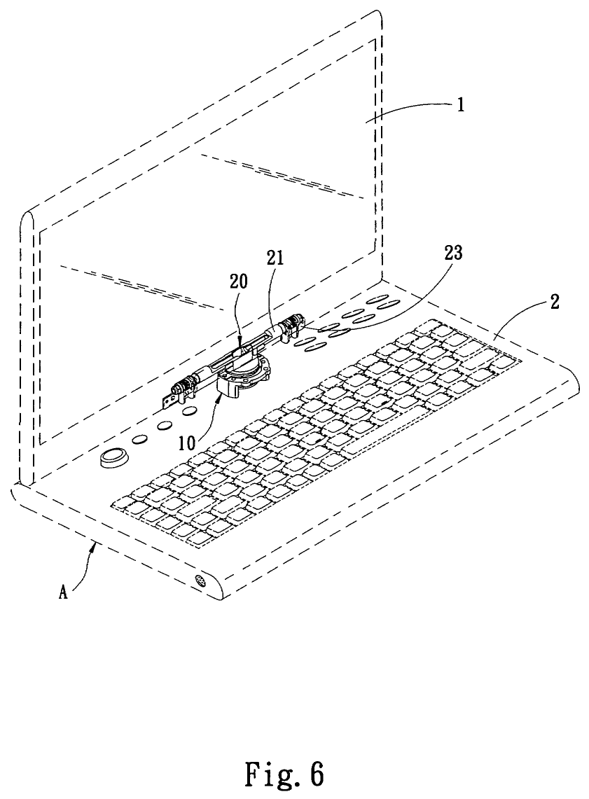

Referring to FIG. 1 for a preferred embodiment of the present invention, a rotating hinge is connected to a display 1 and a main body 2 (as shown in FIG. 6) of an electronic device A, and the display 1 can be spread open and rotated with respect to the main body 2. The rotating hinge with an elevating structure of the invention comprises a fixed base 10, a rotating support base 20, a guide plate 40 and a limit plate 50.

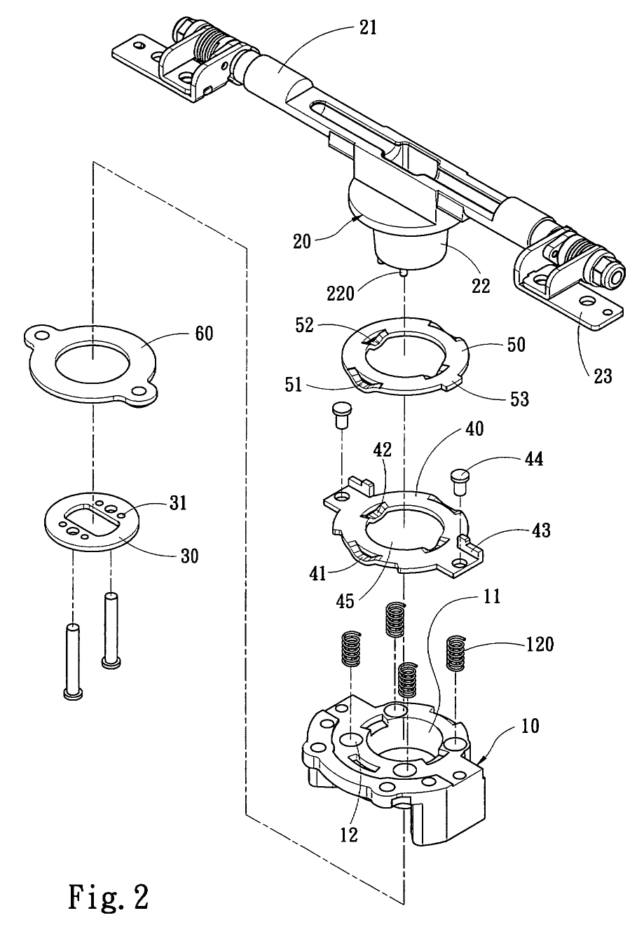

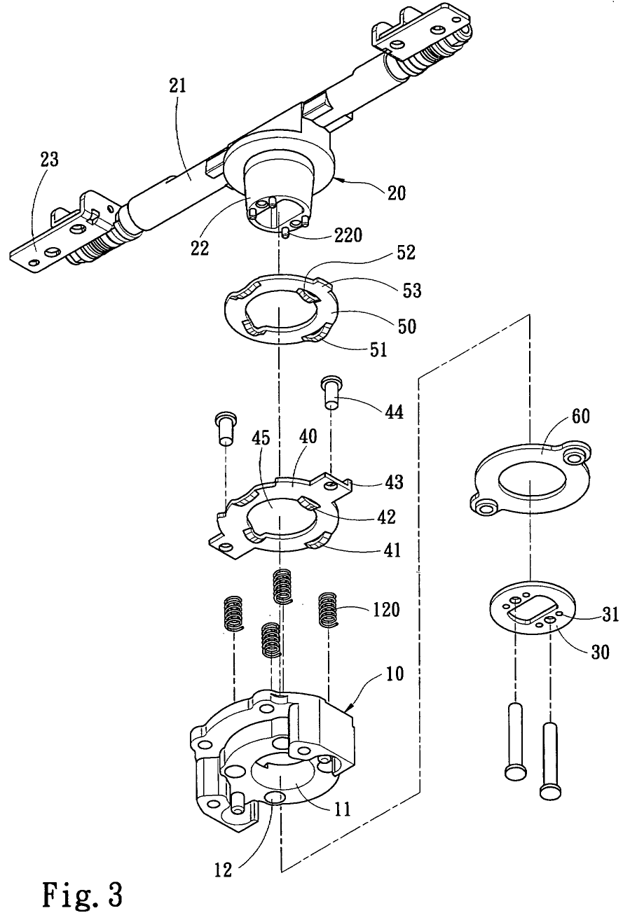

Referring to FIGS. 2 and 3, the rotating support base 20 is installed at the top of the fixed base 10 and includes an axle rod 21 installed on the display 1, a driving portion 22 linked with the axle rod 21 and two fixing members 23 disposed on both ends of the axle rod 21 for mounting the display 1, such that the display 1 can use the axle rod 21 as the axis to spread open the display 1 with respect to the main body 2. The rotating support base 20 further includes a rotating path with respect to the fixed base 10, so that the display 1 can be rotated with respect to the main body 2. The fixed base 10 includes a penetrating hole 11 and a guide plate 40 disposed at the upper edge of the penetrating hole 11, and the guide plate 40 is passed into the fixed base 10 and fixed to the fixed base by a fixing element 44. The driving portion 22 is passed into the penetrating hole 11 disposed in the fixed base 10, and a limit plate 50 is sheathed onto the driving portion 22 for a link, and the guide plate 40 and the limit plate 50 has internal and external positioning grooves 42, 41 and internal and external positioning protrusions 52, 51 corresponding to each other. The guide plate 40 has a through hole 45, and the plurality of internal and external positioning grooves 42, 41 are disposed in pairs at the circumference of the through hole 45 and the external periphery of the guide plate 40.

The internal and external positioning grooves 42, 41 are designed according to an angle such as 0 degree and 180 degrees required for the positioning, when the hinge is rotated. The two external positioning grooves 41 are disposed equidistantly at the positions 180 degrees apart with each other on the external circumference of the guide plate 40, and the two internal positioning grooves 42 are disposed equidistantly on the internal circumference of the through hole 45, and the number and angle of the internal positioning grooves 42 correspond to those of the external positional grooves 41 and both external and internal positioning grooves 41, 42 are disposed alternately with each other. A lower end of the rotating support base 20 has a limit plate 50 coupled to the guide plate 40 and linked to the rotating support base 20, and the limit plate 50 has a set of internal positioning protrusion 52 and external positioning protrusion 51 corresponding to the positions of the internal and external positioning grooves 42, 41 of the guide plate 40, and the internal and external positioning protrusions 52, 51 keep a four-point contact with the display 1 to achieve the effect of resisting vibrations.

The rotating member 30 is disposed at the bottom of the fixed base 10 and connected with the driving portion 22 to produce a link, and the connection is achieved by connecting a plurality of positioning pillars 220 disposed at the bottom of the driving portion 22 into a plurality of positioning holes 31 of the rotating member 30. The fixed base 10 includes at least one containing portion 12, and the containing portion 12 includes a resilient unit 120 that connects and presses the guide plate 40, and the bottom of the containing portion 12 further includes a fixing plate 60, and another end of the resilient unit 120 connects and presses the fixing plate 60.

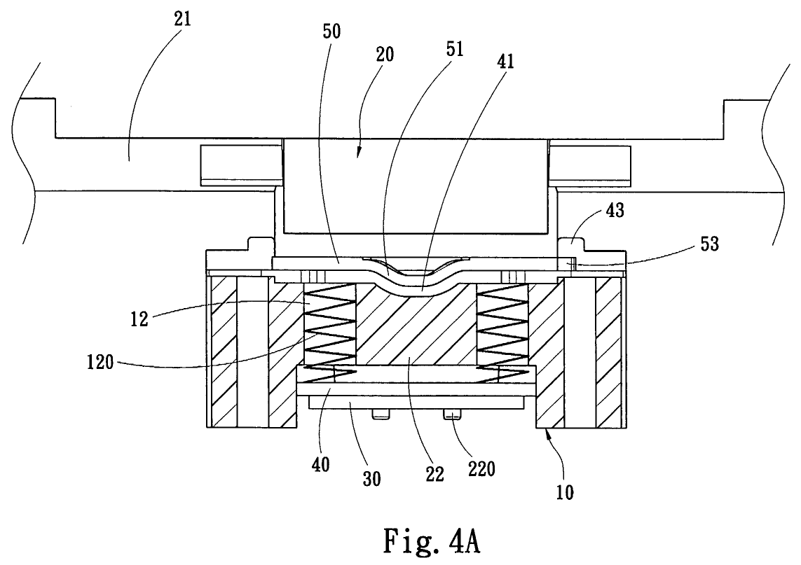

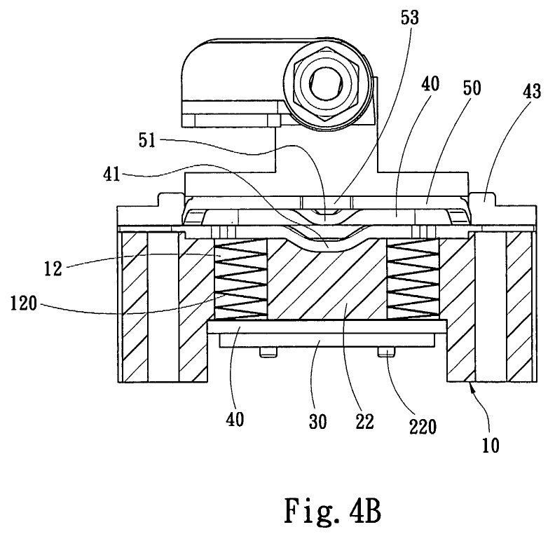

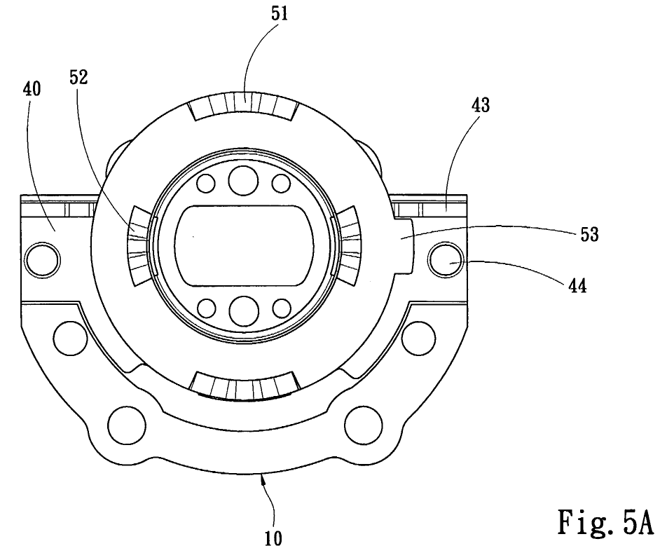

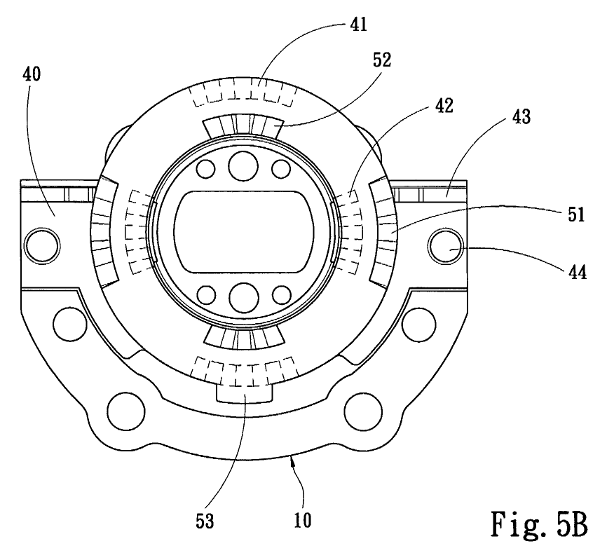

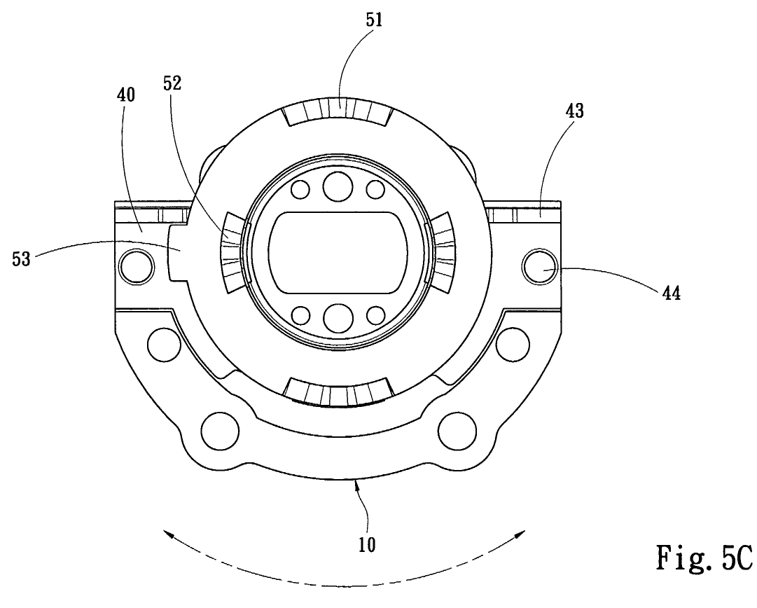

Referring to FIGS. 4A.4B, 5A.5C, and 6, a rotating hinge is applied in an electronic device A of a notebook computer in accordance with a preferred embodiment of the present invention, a display 1 of the notebook computer can be spread open and rotated with respect to a main body 2. The display 1 normally defines a rotation angle of 0 degree with respect to the main body 2, and the internal and external positioning protrusions 52, 51 disposed at the internal and external positioning grooves 42, 41 can position the display 1 at a rotation position of the main body 2 (as shown in FIGS. 4A and 5A). If a user wants to view the display 1 at a different angle, the user can turn the display 1 with respect to the main body 2 by the rotating support base 20, and the driving portion 22 synchronously moves the rotating member 30 disposed under the driving portion 22 in a rotating path of the rotating support base 20. The walls of the internal and external positioning protrusions 52, 51 and the internal and external positioning grooves 42, 41 press with each other and produce vertically up and down displacements to elevate the rotating support base 20 to a specific height, and the resilient unit 120 pushes the fixing plate 60 to give a tightness required for the rotating process, and the resilient unit 120 stores a resilience for resuming the rotating support base 20 to its original position (as shown in FIGS. 4B and 5B). Before the display 1 at a protruding edge 53 is moved to another stop plate 43 (or a rotating path is defined between the protruding edge 53 and the two stop plates 43), the display 1 can be turned to any angle to facilitate users to view the display 1. When the rotating support base 20 and the fixed base 10 are rotated, the internal and external positioning grooves 42, 41 and the internal and external positioning protrusions 52, 51 elevate and fix the rotating support base 20. After the rotating support base 20 rises, there are four or more points of contact of the internal and external positioning protrusions 52, 51 disposed at the internal and external circumferences of the guide plate 40, such that the elevated rotating support base 20 can stably maintain a four-point contact to prevent and resist vibrations. Besides the display 1 can be turned with respect to its main body 2, the display 1 also can be elevated or descended with respect to the main body 2 during the rotating process, so as to prevent the display 1 from touching the keyboard. As a result, the display 1 can be designed at a lower position to reduce the overall volume of the electronic device A and give a more artistic and harmonic appearance to the notebook computer. If a user turns the display 1 to a position of 180 degrees with respect to the main body 2 (as shown in FIG. 5C), the positions of the internal and external positioning protrusions 52, 51 match with the positions of the internal and external positioning grooves 42, 41 again, and the resilience stored in the resilient unit 120 is released to position the internal and external positioning protrusions 52, 51 of the limit plate 50 into the internal and external positioning grooves 42, 41 of the guide plate 40 again. After the rotating support base 20 is turned to a predetermined position, the internal and external positioning grooves 42, 41 can be matched with the internal and external positioning protrusions 52, 51, and the rotating support base 20 can be elevated. The resilience of the resilient unit 120 enhances the touch feel of the positioning of the rotating support base 20, and the protruding edge 53 between the two stop plates 43 is displaced to define a 180-degree rotating path of the rotating support base 20 with respect to the fixed base 10 and stopped by another stop plate 43. By then, users can no longer turn the display 1 further, and thus the rotating path of the rotating hinge with an elevating structure is restricted to 180 degrees, so as to prevent further turning that may twist the signal line. The positioning relation defined by turning the rotating support base 20 to 0 degree and 180 degrees with respect to the fixed base 10 to improve the touch feel and stability when the front side and backside of the display 1 are positioned.

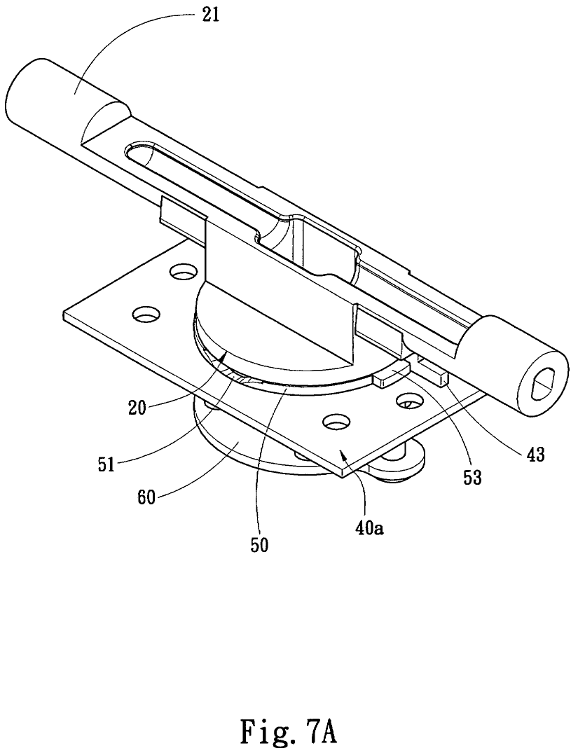

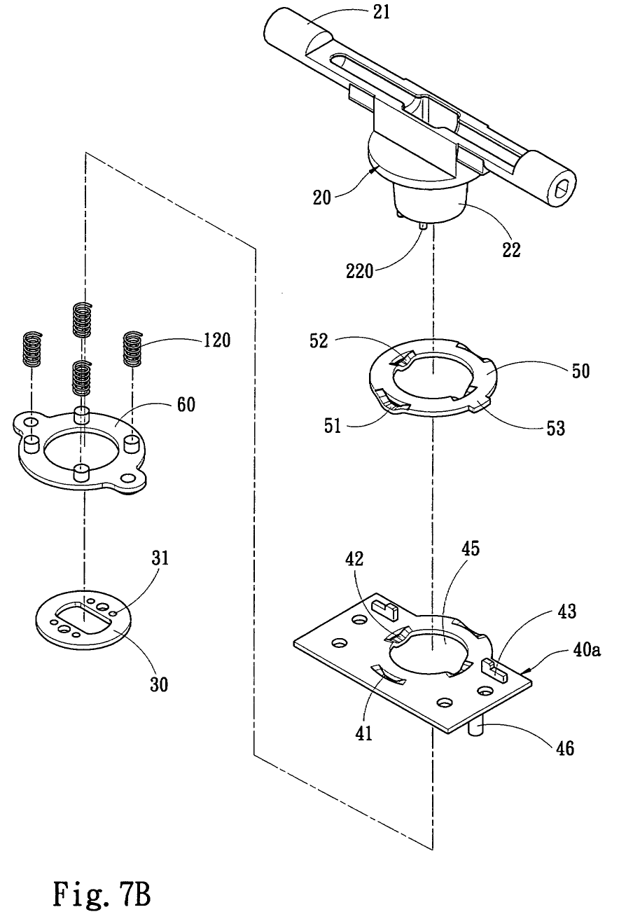

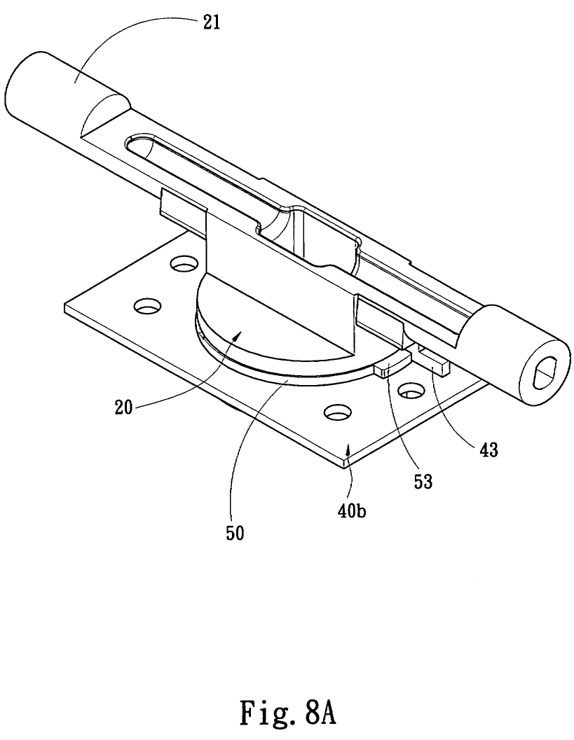

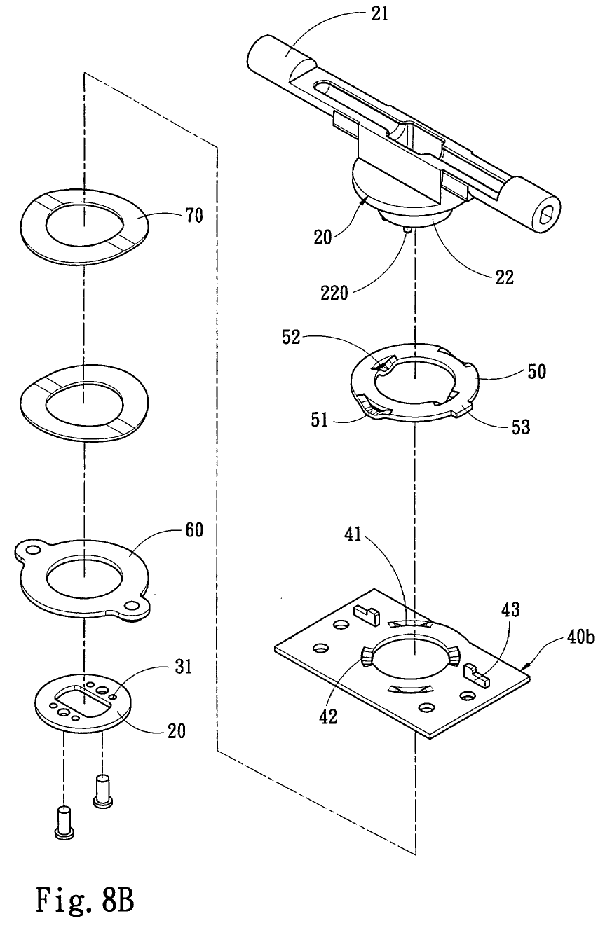

The shape of components of the present invention is not limited to the foregoing embodiments only, but the guide plates 40a, 40b also can be rectangular plates, and the positions of the internal and external positioning grooves 42, 41 can be adjusted slightly on the guide plates 40a, 40b, or an elastic plate 70 can be installed between the guide plate 40b and the fixing plate 60 according to actual needs for changing the detailed structure as shown in FIGS. 7A˜7B or 8A˜8B.

While the invention has been described by means of specific embodiments, numerous modifications and variations could be made thereto by those skilled in the art without departing from the scope and spirit of the invention set forth in the claims.

What is claimed is:

1. A rotating hinge with an elevating structure, having a fixed base and a rotating support base capable of rotating with respect to each other, characterized in that:
an upper end of said fixed base is fixed with a guide plate, and said guide plate has a through hole, and two or more external positioning grooves disposed equidistantly on the external circumference of said guide plate, and at least two internal positioning grooves disposed equidistantly on the external circumference of said through hole, and a lower end of said rotating support base has a limit plate coupled to said guide plate and linked by said rotating support base, and said limit plate corresponds to an internal positioning protrusion and an external positioning protrusion corresponding to said internal and external positioning grooves on said guide plate respectively, such that when said rotating support base rotates, the walls of said internal and external positioning protrusions and said internal and external positioning grooves press each other to produce an ascending or descending displacement, and said internal and external positioning protrusions disposed in said internal and external positioning grooves define a positioning relation.

2. The rotating hinge with an elevating structure of claim 1, wherein said limit plate has a protruding edge disposed at a lateral side of said limit plate, and said guide plate further has two corresponding stop plates, and said protruding edge presses against said stop plate to define a rotatable angle of said rotating support base with respect to said fixed base.

3. The rotating hinge with an elevating structure of claim 2, wherein said two stop plates are situated at the 180-degree position to define a 180-degree rotatable angle of said rotating support base with respect to said fixed base.

4. The rotating hinge with an elevating structure of claim 1, wherein said internal and external positioning protrusions and said internal and external positioning grooves constitute said positioning relation at said rotating support base with respect to a rotating path of 0 degree and 180 degrees from said fixed base.
